(19) United States
(12) Patent Application Publication
(10) Pub. No.: US 2026/0307064 A1
(43) Pub. Date: Oct. 8, 2026

(54) METHOD FOR PRODUCING FE-DOPED BETA ZEOLITE CATALYST MONOLITHS

(71) Applicant: BASF SE, Ludwigshafen am Rhein (DE)

(72) Inventors: Lukasz KARWACKI, Ludwigshafen am Rhein (DE); Esther GROENEVELD, Gorinchem (NL); Aris GOULAS, Amsterdam (NL); Fred BORNINKHOF, De Meem (NL); Peter BERBEN, Maam (NL)

(21) Appl. No.: 19/479,034

(22) PCT Filed: Apr. 26, 2024
(86) PCT No.: PCT/EP2024/061527

§ 371 Date: Oct. 27, 2025

(30) Foreign Application Priority Data
Apr. 28, 2023 (EP) 23170764.7

(51) Int. Cl. B01J 29/76; B01D 53/86; B01D 53/94; B01J 35/56; B01J 35/61; B01J 35/63; B01J 35/66; B01J 35/67; B01J 37/00; B01J 37/08

(52) U.S. Cl. CPC B01J 29/7615; B01D 53/8628; B01D 53/9418; B01J 35/56; B01J 35/615; B01J 35/635; B01J 35/67; B01J 35/695; B01J 37/0018; B01J 37/08; B01D 2251/2062; B01D 2257/404; B01D 2258/01

(57) ABSTRACT

A method for producing a three-dimensional porous Fe-doped beta zeolite catalyst monolith of stacked catalyst fibers, comprising the following steps:
a) Preparing a suspension paste in a liquid aqueous diluent of Fe-doped beta zeolite particles and which suspension furthermore comprises a binder material in a maximum amount of 50 wt %, based on the amount of Fe-doped beta zeolite particles and a plasticizer and a pore-forming material, each in a maximum amount of 10 wt %, based on the amount of Fe-doped beta zeolite particles, and a peptization agent in a maximum amount of 5 wt %, based on the amount of Fe-doped beta zeolite particles, all particles in the suspension having a number average particle size in the range of from 0.05 to 700 μm,
b) extruding the paste of step a) through one or more nozzles to form fibers, and depositing the extruded fibers to form a three-dimensional porous catalyst monolith precursor,
c) drying the porous catalyst monolith precursor to remove the liquid diluent,
d) performing a temperature treatment of the dried porous catalyst monolith precursor of step c) at a temperature in the range of from 300 to 600° C., to form the Fe-doped beta zeolite catalyst monolith,
wherein no temperature treatment of the porous catalyst monolith precursor or porous catalyst monolith at temperatures above 600° C. is performed and wherein preferably no further catalytically active metals, metal oxides or metal compounds are applied to the surface of the Fe-doped beta zeolite particles, the catalyst monolith precursor or Fe-doped beta zeolite catalyst monolith with the exception of copper.

The invention relates to a method for producing a three-dimensional porous Fe-doped beta zeolite catalyst monolith of stacked catalyst fibers, the thus obtained monolith and its use.

Typically, inorganic catalysts are produced as powders and as shaped bodies in the form of extrudates, granules, pellets, spheres, tablets or extruded monolith or honeycomb structures.

Current commercial catalyst shaped bodies are limited by their size. The smallest available commercial size is approximately 1.2 mm (for extrudates). It has advantages for certain catalytic applications to use smaller diameter extrudates due to increased geometric surface area and shorter pore diffusion lengths. However, such smaller extrudates cannot be used in commercial reactors set-ups due to too low strength and too high pressure drop. For multi-tubular reactors it is required to fill reactor tubes very homogenously with a catalyst material. To ensure reactor balance, today's catalysts rely on cut extrudates or tablets to ensure homogeneous particle size. Likewise, the loading of such reactors is time-consuming and labor- and cost-intensive. It would be desirable to fill reactors, especially multi-tubular reactors with shaped bodies of identical size and shape and enhanced mechanical properties. For today's Fe-doped beta zeolite catalysts (e. g. for selective catalytic reduction of NOₓ with NH₃ or N₂0 abatement) such shaped bodies offering the combination of these advantages are not known.

Fe-doped beta zeolite catalysts may be employed as extrudates with standard diameters ranging from 1.2 mm to 12.0 mm. Special cross sections such as stars, trilobes, quadrolobes and ring-type geometries are possible. Alternatively, tablets having a diameter between 1.5 and 20.0 mm are employed. The different catalyst shapes lead to different pressure drops in the reactor.

Alternative processes which allow for a greater variety of shapes in comparison to a linear stretched honeycomb structure can be prepared e. g. by rapid prototyping processes. The process described in U.S. Pat. No. 8,119,554, for example, involves the production of a shaped body by means of a powder-based rapid prototyping process, in which a binder material is selectively introduced in an inorganic catalyst powder to form the three-dimensional structure.

A further production process often named robocasting can be employed. In this method, a paste of the catalyst material particles is extruded into strands which are deposited in stacked layers to form the desired three-dimensional structure. Subsequently, the structure is dried and heat treated. The production of regenerable diesel soot particulate filters by robocasting methods is disclosed in U.S. Pat. No. 7,527,671.

Extrusion-based 3D printing of molecular sieve zeolite for gas absorption applications is described in Contributed Papers from Materials Science and Technology 2018 (MS&T18), Oct. 14-18, 2018, pages 33-40. Zeolites 13X and 5A, 4A and 3A are mixed with bentonite clay as a binder, methylcellulose as a plasticizing organic binder, and poly(vinyl) alcohol (PVA) as a co-binder. A homogenous aqueous slurry with suitable viscosity was obtained, which was 3D printed to form a circular grated disc or a square grated design. The 3D-printed zeolites 3A and 4A monoliths contained 90 wt % zeolite, 7 wt % bentonite clay, 2.0 wt % methylcellulose and 1.0 wt % PVA, or 95 wt % zeolite, 3 wt % bentonite clay, 1.5 wt % methylcellulose and 0.5 wt % PVA. It is stated that an increased hardness value after sintering is an indication of the better mechanical strength of 3D-printed zeolite samples, but on the other hand, increased hardness value after sintering makes them brittle.

Catalysis Today, 216 (2013), pages 18-23 discloses macroporous supports with a thin active layer of zeolite. Three dimensional fiber deposition allows for different architectures for the catalyst support. A wash coating method was optimized for the coating of ZSM-5 on different types of support. The manufactured catalysts were evaluated for the conversion of methanol to light olefins.

Chemical Papers 68 (9) 1143-1153 (2014) discloses the conversion of methanol to light olefins (MTO) using structured catalysts. Important aspects such as thickness of the coating, crystal size of the zeolite and architecture of the support on the mass transfer properties of the final catalyst are highlighted. Pressure drop as a function of specific geometric surface area is depicted for different shapes in FIG. 2. At the same specific surface area, the samples show different pressure drops, from high to low: spheres (packed bed), foams, three dimensional fiber deposition (3DFD) 1-3, 3DFD 1-1, and honeycombs. The 3DFD surface is coated with ZSM-5, see FIG. 3.

Int. J. Appl. Ceram. Technol., 9 [5], pages 902-910 (2012) discloses ceramic processing techniques for catalyst design: formation, properties, and catalytic example of ZSM-5 on 3-dimensional fiber deposition support structures. (1.1) stacking and (1.3.5) stacking of the 3DFD support are disclosed.

US 2007/0259770 and US 2009/0291824 describe extruded catalyst bodies, e.g. honeycomb bodies, wherein the extrusion paste contains significant amounts of fiber/fibrous fillers.

For the selective catalytic reduction of NOₓ with NH₃, often Fe-beta zeolites are employed, compare Chinese Journal of Catalysis 37 (2016), pages 2069-2078. Beta zeolite has a three dimensional channel structure with a 12-membered ring assembled from 4-, 5-, 6-membered rings and is an attractive host material for metal loading. The catalyst is employed in the form of pal-lets which were crushed to 20-40 mesh.

Methods and catalysts for the reduction of nitrogen oxides with ammonia using promoted zeolite catalysts are described in a number of patent applications and patents, for example U.S. Pat. No. 4,961,917, EP 3 708 252 A1, WO 02/41991, WO 03/022430, WO 2013/118064 A1 and US 2013/0202524 A1. The catalysts are typically employed as molded 1.5 to 3 mm strands, prepared by mixing the metal-loaded zeolite beta materials with 20-50 wt % of aluminium oxide based on 100 wt % of the resulting mixture. The molded mixture is calcined at 450° C. for 4 hours for obtaining the required catalyst samples, see the examples.

To obtain high external surface areas for the catalysts, e. g. for diffusion limited reactions, or high packing densities with low void volume, in fixed-bed catalyst reactors, the use of smaller catalyst particles would be necessary. In mass-transfer limited reactions the performance of small catalyst particles is better than that of larger extrudates. A disadvantage, however, is that smaller extrudates show a higher pressure drop in the packed bed which will limit their application in chemical reactors. Furthermore, the mechanical strength of these small extrudates is typically not sufficient to form a packed bed reactor on commercial scale.

The current tertiary N₂O abatement catalyst technology is applied in the form of catalyst extruded bodies. Since the extrudates require shapes with a high external surface area (e.g. star shape) they are difficult to produce and experience high levels of mechanical attrition. Additionally, to achieve a proper gas mixing, significant amount of reactor volume (up to 60%) is filled with a filler material allowing uniform mixture of NOx, N₂O and reducing agent.

The object underlying the present invention is to provide a Fe-doped beta zeolite catalyst which has a high external surface area or high packing density. The catalyst structure should be sufficiently mechanically stable so that packed catalyst beds can be formed in a reactor, which show a low pressure drop and low attrition.

The object is achieved according to the present invention by a method for producing a three-dimensional porous Fe-doped beta zeolite catalyst monolith of stacked catalyst fibers, comprising the following steps:
a) Preparing a suspension paste in a liquid aqueous diluent of Fe-doped beta zeolite particles and which suspension furthermore comprises a binder material in a maximum amount of 50 wt %, based on the amount of Fe-doped beta zeolite particles and a plasticizer and a pore-forming material, each in a maximum amount of 10 wt %, based on the amount of Fe-doped beta zeolite particles, and a peptization agent in a maximum amount of 5 wt %, based on the amount of Fe-doped beta zeolite particles, all particles in the suspension having a number average particle size in the range of from 0.05 to 700 μm,
b) extruding the paste of step a) through one or more nozzles to form fibers, and depositing the extruded fibers to form a three-dimensional porous catalyst monolith precursor,
c) drying the porous catalyst monolith precursor to remove the liquid diluent,
d) performing a temperature treatment of the dried porous catalyst monolith precursor of step c) at a temperature in the range of from 300 to 600° C., to form the Fe-doped beta zeolite catalyst monolith,
wherein no temperature treatment of the porous catalyst monolith precursor or porous catalyst monolith at temperatures above 600° C. is performed and wherein preferably no further catalytically active metals, metal oxides or metal compounds are applied to the surface of the Fe-doped beta zeolite particles, the catalyst monolith precursor or Fe-doped beta zeolite catalyst monolith with the exception of copper and cobalt.

The technical solution mentioned here offers significantly higher external surface area of active mass, due to the narrow diameter of individual fibers of which 3D micro extruded shape originates while allowing very good mixing, hence reducing reactor size requirement. The invention enables to offer a higher performing catalyst than the existing extrudates, while also being able to challenge the monolith coated solutions of competition. Use of the 3D micro extruded materials allows the application of catalyst in the units with physical limitations related to off gas reactor treatment where conventional catalyst would not be able to perform sufficiently, thus, allowing further reduction of N₂O emissions in the processes and plants that are currently not having an optimal, or any N₂O abetment unit. Additionally, 3D micro extruded material allows application of this catalyst to mobile application where the classical extrudates would lead to too high pressure drop.

Removal of the N₂O and/or NOₓ from off gas of chemical plants, e.g., nitric acid or adipic acid plants, stationary power generators and mobile sources, e.g., marine vessels engines, becomes possible. Marine applications and nitric and adipic acid plants are a preferred fields of application.

The Fe-doped beta zeolite particle having a number average particle size in the range of from 0.5 to 500 μm can be obtained according to a number of processes which are for example disclosed in US 2013/0202524 A1, WO 2013/118064, WO 03/022430, WO 02/41991, EP 3 708 252 A1 and U.S. Pat. No. 4,961,917. The desired or required particle size can be obtained by crushing or milling the Fe-doped beta zeolite to the desired particle size. The particle size can be determined optically by using a camsizer.

A process for the production of a zeolitic material having a BEA-type framework structure in the present invention comprising YO₂ and X₂O₃ comprises the steps of
(1) preparing a mixture comprising one or more sources for YO₂, one or more sources for X₂O₃, and seed crystals comprising one or more zeolitic materials having a BEA-type framework structure;
(2) crystallizing the mixture obtained in step (1); and
(3) subjecting the zeolitic material having a BEA-type framework structure obtained in step (2) to an ion-exchange procedure with Cu and/or Fe; wherein Y is a tetravalent element, and X is a trivalent element, wherein the mixture provided in step (1) and crystallized in step (2) does not contain an organotemplate as structure-directing agent, and
wherein the total amount of Cu and/or Fe in the ion-exchanged material obtained in step (3) ranges from 0.1 to 2 wt % calculated as Fe₂O₃ and CuO,
wherein preferably the zeolitic material obtained in step (2) comprises one or more alkali metals M, wherein M is selected from the group consisting of Li, Na, K, Cs, and combinations of two or more thereof,
wherein preferably Y is selected from the group consisting of Si, Sn, Ti, Zr, Ge, and a mixture of two or more thereof,
wherein preferably the one or more sources for YO₂ provided in step (1) comprises one or more silicates,
wherein preferably the one or more sources for YO₂ further comprises one or more silicas in addition to the one or more silicates,
wherein preferably the mixture provided in step (1) comprises water glass,
wherein preferably X is selected from the group consisting of Al, B, In, Ga, and a mixture of two or more thereof,
wherein preferably the one or more sources for X₂O₃ comprises one or more aluminate salts,
wherein preferably the molar ratio YO₂:X₂O₃ of the mixture according to step (1) ranges from 1 to 200,
wherein preferably the amount of seed crystals comprised in the mixture according to step (1) ranges from 0.1 to 30 wt.-% based on 100 wt.-% of YO₂ in the one or more sources for YO₂,
wherein preferably the mixture according to step (1) further comprises one or more solvents.

A process for the treatment of a gas stream containing nitrogen oxides according to the present invention comprises the steps of:
(1) providing a gas stream containing one or more nitrogen oxides;
(2) contacting the gas stream provided in step (1) with a transition metal containing zeolitic material having a BEA-type framework structure for reacting one or more of the nitrogen oxides;
wherein the zeolitic material is obtainable from an organotemplate-free synthetic process,
wherein preferably the one or more nitrogen oxides comprise one or more compounds selected from the group consisting of N₂O, NO, NO₂, N₂O₃, N₂O₄, N₂O₅, NO₃, and mixtures of two or more thereof, preferably one or more
compounds selected from the group consisting of N₂O, NO, NO₂, and mixtures of two or more thereof, wherein even more preferably the one or more nitrogen oxides contained in the gas stream provided in step (1) comprise N₂O and/or NOₓ,
wherein preferably the gas stream provided in step (1) comprises N₂O in an amount comprised in the range of from 10 to 10,000 ppmv, preferably from 50 to 5,000 ppmv, more preferably from 100 to 3,000 ppmv, more preferably from 500 to 2,000 ppmv, more preferably from 700 to 1,500 ppmv, and even more preferably from 900 to 1,100 ppmv,
wherein preferably the gas stream provided in step (1) comprises NOₓ in an amount comprised in the range of from 0 to 5,000 ppmv, more preferably from 50 to 2,000 ppmv, more preferably from 100 to 1,000 ppmv, more preferably from 150 to 800 ppmv, more preferably from 200 to 600 ppmv, and even more preferably from 250 to 500 ppmv,
wherein preferably the gas stream provided in step (1) comprises N₂O and NOₓ in a molar ratio of NOₓ:N₂O comprised in the range of from 1:50 to 5:1, preferably of from 1:20 to 2:1, more preferably of from 1:10 to 1:1, more preferably of from 1:5 to 1:1.5, and even more preferably of from 1:4 to 1:2,
wherein preferably the gas stream provided in step (1) further comprises one or more reducing agents,
wherein preferably the one or more reducing agents comprises one or more compounds selected from the group consisting of hydrocarbons, carbon monoxide, hydrogen, and combinations of two or more thereof, wherein the one or more reducing agents preferably comprise one or more hydrocarbons, more preferably one or more hydrocarbons selected from the group consisting of C₁ to C₆ alkanes, preferably C₁ to C₅ alkanes, wherein more preferably the one or more reducing agents comprises one or more hydrocarbons selected from the group consisting of methane, ethane, propane, and butane, wherein even more preferably the one or more reducing agents comprise methane and/or propane and/or butane, more preferably methane and/or propane, and wherein even more preferably the one or more reducing agents comprise propane,
wherein preferably the stoichiometric ratio of the one or more reducing agents, preferably of the one or more hydrocarbons, to the one or more nitrogen oxides, preferably to N₂O and/or NOₓ, is comprised in the range of from 0.05 to 50, preferably of from 0.1 to 20, more preferably of from 0.15 to 10, more preferably of from 0.25 to 5, more preferably of from 0.35 to 2, more preferably of from 0.5 to 1.5, more preferably of from 0.65 to 1.25, and even more preferably of from 0.75 to 1.1,
wherein preferably the reducing agent does not comprise ammonia and/or urea, wherein preferably the reducing agent does not comprise ammonia, urea, or any derivatives of ammonia or urea, wherein more preferably the reducing agent does not comprise a nitrogen containing compound wherein nitrogen is present in a negative oxidation state, and wherein even more preferably the reducing agent does not comprise a nitrogen containing compound,
wherein preferably the gas stream provided in step (1) comprises from 0 to 10% by volume of oxygen, preferably from 0.5 to 8% by volume, more preferably from 1 to 6% by volume, more preferably from 1.5 to 5% by volume, more preferably from 2 to 4% by volume, and even more preferably from 2.5 to 3.5% by volume of oxygen,
wherein preferably the gas stream provided in step (1) comprises from 0 to 10% by volume of H₂O, preferably from 0.05 to 5% by volume, more preferably from 1 to 3% by volume, more preferably from 0.1 to 2% by volume, more preferably from 0.15 to 1% by volume, and even more preferably from 0.2 to 0.5% by volume of H₂O,
wherein preferably the gas stream provided in step (1) comprises one or more waste gases, preferably one or more waste gases from one or more industrial processes, wherein more preferably the waste gas stream comprises one or more waste gas streams obtained in processes for producing adipic acid, nitric acid, hydroxylamine derivatives, caprolactame, glyoxal, methyl-glyoxal, glyoxylic acid or in processes for burning nitrogeneous materials, including mixtures of waste gas streams from two or more of said processes, wherein even more preferably the waste gas stream comprises one or more waste gas streams obtained in processes for producing adipic acid and/or nitric acid,
wherein preferably the gas stream provided in step (1) comprises one or more waste gases from an internal combustion engine, preferably from an internal combustion engine which operates using a fuel comprising C₁ to C₁₀ hydrocarbons or mixtures of two or more thereof, more preferably using a gas comprising C₁ to C₈ hydrocarbons or mixtures of two or more thereof, more preferably C₁ to C₆ hydrocarbons or mixtures of two or more thereof, more preferably C₁ to C₅ hydrocarbons or mixtures of two or more thereof, more preferably using a gas comprising methane and/or propane, and even more preferably using a gas comprising methane,
wherein preferably the one or more waste gases comprised in the gas stream provided in step (1) have not been subject to a catalytic treatment procedure for the abatement of N₂O and/or NOₓ beforehand, wherein preferably the one or more waste gases have not been subject to a catalytic treatment procedure for the abatement of one or more of the nitrogen oxides beforehand, wherein more preferably the one or more waste gases have not been subject to a treatment procedure for the abatement of N₂O and/or NOₓ beforehand, and wherein even more preferably the one or more waste gases have not been subject to a treatment procedure for the abatement of one or more of the nitrogen oxides beforehand,
wherein preferably the contacting of the gas stream with the transition metal containing zeolitic material in step (2) is conducted at a temperature comprised in the range of from 250 to 550° C., preferably of from 300 to 500° C., more preferably of from 325 to 450° C., more preferably of from 350 to 425° C., more preferably of from 380 to 420° C., and even more preferably of from 390 to 410° C.
wherein preferably the contacting of the gas stream with the transition metal containing zeolitic material in step (2) is conducted at a pressure comprised in the range of from 1 to 50 bar, preferably of from 2 to 30 bar, more preferably from 3 to 25 bar, more preferably of from 4 to 20 bar, more preferably of from 5 to 15 bar, more preferably of from 6 to 10 bar, more preferably of from 7 to 9 bar, and even more preferably of from 7.5 to 8.5 bar,
wherein preferably the process is preferably a continuous process, and wherein more preferably the contacting of the gas stream with the transition metal containing zeolitic material in step (2) is conducted at a gas hourly space velocity (GHSV) comprised in the range of from 1,000 to 100,000 h⁻¹, more preferably of from 2,500 to 50,000 h⁻¹, more preferably of from 5,000 to 30,000 h⁻¹, more preferably of from 10,000 to 25,000 h⁻¹, and even more preferably of from 15,000 to 22,500 h⁻¹.

An apparatus for the treatment of a gas stream containing nitrogen oxides and preferably containing NOₓ and/or N₂O according to the present invention comprises:
(i) a catalyst bed provided in fluid contact with the gas stream to be treated; wherein the catalyst bed comprises a transition metal containing zeolitic material having a BEA-type framework structure, the zeolitic material being obtainable from an organotemplate-free synthetic process, wherein preferably the catalyst bed is a fixed bed catalyst or a fluidized bed catalyst, preferably a fixed bed catalyst,
the apparatus preferably further comprising:
(ii) one or more devices provided upstream of the catalyst bed for injecting one or more reducing agents into the gas stream.

The one or more transition metals contained in the zeolitic material in the present invention is preferably selected from the group consisting of Co, Ni, Cu, Fe, Ag, Au, Pt, Pd, Rh and combinations of two or more thereof, more preferably from the group consisting of Co, Ni, Cu, Fe, and combinations of two of more thereof, more preferably from the group consisting of Co, Cu, Fe, and combinations of two or more thereof, wherein even more preferably, the zeolitic material contains Cu and/or Fe, preferably Fe,
wherein preferably the one or more transition metals are contained in the zeolitic material as non-framework elements,
wherein preferably the BEA-type framework structure of the zeolitic material comprises YO₂ and X₂O₃, wherein Y is a tetravalent element, and X is a trivalent element,
wherein preferably Y is selected from the group consisting of Si, Sn, Ti, Zr, Ge, and a mixture of two or more thereof, Y preferably being Si,
wherein preferably X is selected from the group consisting of Al, B, In, Ga, and a mixture of two or more thereof, X preferably being Al,
wherein preferably the YO₂:X₂O₃ molar ratio ranges from 2 to 100, more preferably from 4 to 70, more preferably from 5 to 50, more preferably from 6 to 30, more preferably from 7 to 20, more preferably from 8 to 15, more preferably from 9 to 13, and even more preferably from 10 to 11,
wherein preferably the molar ratio of the one or more transition metals to X₂O₃ comprised in the BEA-type framework structure ranges from 0.005 to 10, more preferably from 0.01 to 5, more preferably from 0.05 to 2.5, more preferably from 0.1 to 1.5, more preferably from 0.25 to 1, and even more preferably from 0.3 to 0.7,
wherein preferably the X-ray diffraction pattern of the zeolitic material having a BEA-type framework structure comprises at least the following reflections:

| | Diffraction angle 2Θ° |
|---|---|
| Intensity (%) | [Cu K(alpha 1)] |
| [11-31] | [21.07-21.27] |
| 100 | [22.12-22.32] |
| [13-33] | [25.01-25.21] |
| [17-37] | [25.53-25.73] |
| [13-33] | [26.78-26.98] |
| [11-31] | [28.39-28.59] |
| [22-42] | [29.24-29.44] |
| [6-26] | [30.00-30.20] |
| [9-29] | [32.86-33.26] |
| [11-31] | [42.90-43.30] |

wherein 100% relates to the intensity of the maximum peak in the X-ray powder diffraction pattern,
wherein preferably the zeolitic material having a BEA-type framework structure comprises zeolite beta,
wherein preferably the transition metal containing zeolitic material is comprised in a molding.

The catalyst composition in the present invention can comprises a zeolite having a silica to alumina ratio of at least about 10, and a pore structure which is interconnected in all three crystallographic dimensions by pores having an average kinetic pore diameter of at least about 7 Angstroms, e. g. from about 7 to 8 Angstroms, and one, or both of an iron and a copper promoter present in the zeolite, for example, in the amount of from about 0.1 to 30 percent by weight, preferably from about 1 to 5 percent by weight, of the total weight of promoter plus zeolite. The zeolite can comprise one or more of USY, Beta and ZSM-20 besides Beta. A refractory binder may be admixed with the zeolites. An iron-promoted zeolite beta is preferred and has been commercialized for removing NOₓ, by selective catalytic reduction such as from gas turbine exhaust.

The iron-promoted zeolite beta in the present invention has been an effective catalyst for the selective reduction of nitrogen oxides such as by the reduction of nitrogen oxides with ammonia.

Unfortunately, it has been found that under harsh hydrothermal conditions, such as reduction of NOₓ from gas turbine exhaust at temperatures exceeding 500° C., the activity of the iron-promoted zeolite beta begins to decline. This decline in activity is believed to be due to destabilization of the zeolite such as by dealumination and consequent reduction of metal-containing catalytic sites within the zeolite. To maintain the overall activity of NOₓ reduction, a stabilized iron-promoted aluminosilicate zeolite catalyst having the iron in the form of Fe (OH) can be employed,
wherein preferably said iron promoter is present in amounts of 0.1 to 30 weight percent by weight calculated as metal and based, on the total weight of the metal and the zeolite,
wherein preferably said iron is present in the amounts of 0.5 to 2.5 weight percent based on metal,
wherein preferably said zeolite has a silica to alumina ratio of at least about 8 and a pore structure which is interconnected in all three crystallographic dimensions by pores having an average kinetic diameter of at least about 7 Å,
the stabilized iron-promoted aluminosilicate zeolite preferably comprising iron-promoted zeolite beta,
wherein preferably said zeolite beta has a Si/Al ratio of no more than 10,
the stabilized iron-promoted aluminosilicate zeolite preferably having an FT-IR absorption peak at 3680±5 cm⁻¹,
wherein preferably said zeolite has a silica to alumina mole ratio of at least about 8, and a pore structure which is interconnected in all three crystallographic dimensions by pores having an average kinetic pore diameter of at least about 7 Å,
wherein said zeolite is zeolite beta,
wherein preferably said iron-promoter is present in amounts of 0.1 to 30% by weight calculated as metal and based on the total weight of the metal and the zeolite,
wherein preferably said iron is present in amounts of 0.5 to 2.5 weight percent.

A metal-promoted aluminosilicate zeolite having improved stability can be formed in the present invention by presteaming an aluminosilicate zeolite at a temperature of 600° C.-800° C. for a period of time of 0.25 to 8 hours, said presteaming not providing significant dealumination of said aluminosilicate zeolite, subsequently adding metal to said presteamed zeolite,
wherein said metal is iron,
wherein preferably said metal is added in amounts of from 0.1 to 30% by weight calculated as metal based. on the total weight of the metal and aluminosilicate zeolite,
wherein preferably said metal is added in amounts of from 0.5 to 2.5 weight percent based on the total weight of the metal. and the zeolite,
wherein preferably said metal is iron which is present in amounts. of 0.7 to 1.5 weight percent as iron based on the total weight of iron and the zeolite,
wherein preferably said zeolite has a silica to alumina ratio of at least about 8, and a pore structure which is interconnected in all three crystallographic dimensions by pores having an average kinetic pore diameter of at least about 7 Å,
the stabilized aluminosilicate zeolite comprising zeolite beta.

A stable, metal-promoted aluminosilicate zeolite can be prepared by contacting an aluminosilicate zeolite with a lanthinide salt by ion-exchange and subsequent to contact with said lanthinide salt, adding a metal promoter by ionexchange to said lanthinide-treated aluminosilicate zeolite,
wherein preferably said lanthinide salt is a cerium salt,
wherein said metal promoter is iron,
wherein preferably said metal promoter is added in amounts of from 0.1 to 30%. by weight calculated as metal based on the total weight of the metal and zeolite,
wherein preferably said iron is added in amounts of from about 0.5 to 2.5 weight percent,
wherein said zeolite is zeolite beta.

A stabilized iron-promoted aluminosilicate zeolite catalyst in the present invention has the iron in the form of Fe(OH),
wherein preferably said iron promoter is present in amounts of 0.1 to 30 weight percent by weight calculated as metal and based on the total weight of the metal and the zeolite,
wherein preferably said iron is present in the amounts of 0.5 to 4 weight percent, for example 0.5 to 2.5 weight percent based on metal,
wherein preferably said zeolite has a silica to alumina ratio of at least about 8 and a pore structure which is interconnected in all three crystallographic dimensions by pores having an average kinetic diameter of at least about 7 Å,
the stabilized iron-promoted aluminosilicate zeolite comprising iron-promoted zeolite beta, wherein said zeolite beta preferably has a Si/Al ratio of no more than 10.

A method for the reduction of nitrogen oxides with ammonia according to the invention comprises:
contacting a gaseous stream containing nitrogen oxides and ammonia at a temperature of from about 250° C. to 600° C. with a catalyst composition comprising: (a) a zeolite having a silica to alumina ratio of at least about 10, and a pore structure which is interconnected in all three crystallographic dimensions by pores having an average kinetic pore diameter of at least about 7 Angstroms; and (b) a promoter selected from the group consisting of iron and copper in the amount of from about 0.1 to 30 percent by weight, calculated as the metal and based on the total weight of the metal and the zeolite,
wherein preferably the promoter is present in the amount of from about 1 to 5 percent by weight of the total weight of the catalytic material, herein preferably the promoter comprises iron,
wherein the zeolite is selected from the group consisting of Beta,
wherein preferably the catalyst composition further includes a refractory binder admixed with the zeolite.

The temperature treatment in step d) can increase the mechanical strength and cohesion of the monolith and also helps to remove plasticizer and/or organic binders and pore-forming materials, consequently, since transition alumina precursor particles and optionally a binder and/or a plasticizer and pore-forming materials and/or a dopant are employed in step a), the Fe-doped beta zeolite component in the porous catalyst monolith precursor is transformed to form the Fe-doped beta zeolite catalyst monolith.

Thus, in step a) Fe-doped beta zeolite particles are employed.

In this respect, a three-dimensional monolith is a one-piece structure made of at least two stacked layers of fibers.

Step b) is preferably controlled by a control system data set or CAD file as described below, preferably implemented on a computer system.

According to the present invention, it has been found that Fe-doped beta zeolite particles can be employed in a robocasting process, wherein no heat treatment at temperatures above 600° C. is performed in order to obtain mechanically stable catalytically active Fe-doped beta zeolite structures which show a low pressure drop, high packing density and high crushing strength.

The current invention allows to synthesize a catalyst shaped body based on transition alumina with high external surface area and high strength. The high external surface area is obtained by avoiding high temperature treatment and by producing small fibers having preferably a diameter of less than 1.2 mm which can be stacked into a 3D structure which can be a continuous fiber or composed of stacked discontinuous fibers that can be used in commercial applications.

The present invention leads to higher conversion levels and selectivity levels of the Fe-doped beta zeolite catalysts resulting in better product yields. The low pressure drop also enables to increase the mass flow rates and achieve higher throughput per hour again resulting in better product yields and space time yields. It also enables to carry out de-NOₓ reactions in the NH₃-SCR process at lower reaction temperatures, which is beneficial for better process economics. It furthermore enables less catalyst ageing due to shorter diffusion pathways and shorter residence times. Should coke formation occur over the course of the operation of the catalyst, a faster burn off of the carbon for example with hot air or steam is facilitated and less time is required for such regeneration which is beneficial for process economics. Furthermore, new reactors can be designed that are smaller than current set-ups leading to lower investment costs while maintaining the current output (process intensification). In the case of multi-tubular reactors, the loading can be made faster and a more reliable process operation is expected.

Preferably, in the method according to the present invention, no temperature or heat treatment at temperatures above 600° C., more preferably above 500° C. is performed. The process step c) and the process step d) are preferred at temperatures not exceeding 600° C. Most preferably, the temperature treatment is performed at a temperature in the range of from 300 to 600° C., more preferably 400 to 500° C.

The drying in step c) is preferably performed at a temperature in the range of from −100 to less than 500° C., more preferably 0 to 300° C., most preferably 20 to 150° C.

Step d) is preferably performed at a temperature in the range of from 400 to 500° C. and for a duration of 5 to 120 minutes.

The method according to the present invention leads to a three-dimensional porous transition alumina catalyst monolith wherein no further catalytically active metals, metal oxides or metal compounds are applied to the surface of the Fe-doped beta zeolite particles, the catalyst monolith and preferably also are not present in the suspension paste.

If intended, minor amounts of dopants or mixtures of dopants, e. g. selected from chemical compounds of Li, Na, K, Ca, Mg, Ba, B, Ga, Si, Ti, Zr, Fe, W, P or Zn can be present in the suspension paste in a maximum amount of 10 wt %, based on the amount of Fe-doped beta zeolite particles or mixtures thereof, for example 0.1 to 10 wt %, preferably 1.0 to 5.0 wt %, based on the Fe-doped beta zeolite particles. Preferably no dopants are employed or added to the suspension.

The final Fe-doped beta zeolite may also—inadvertently!—contain minor amounts of impurities which may qualify as dopants. In such cases, typical impurities are Li₂O, Na₂O, K₂O, CaO, MgO, BaO, B₂O₃ Ga₂O₃, SiO₂, TiO₂, ZrO₂, ZnO, Fe₂O₃ as well as chlorides, nitrates and sulfates. If doping is not intended—as it is preferred —, these amounts should be as low as possible. Typically for such cases, in the Fe-doped beta zeolite, the amount of such impurities is not higher than 5%, more preferably not higher than 2.5%, specifically not higher than 0.5 wt %, based on the Fe-doped beta zeolite in the monolith. In specific embodiments which are preferred, the content of impurities will be below 0.1 wt %, e. g. in case of ultrapure or high-purity Fe-doped beta zeolite materials, and no dopant is employed or added to the suspension.

Thus, the catalyst monolith preferably does not contain additional catalytically active components like catalytically active metals in the final catalyst monolith, apart from Fe.

The beta zeolite can be prepared as described in the above patent literature.

The BET surface area in the catalyst monolith, as determined by single point adsorption using the BET equation (as e. g. described by G. Sandstede et. al., Chem. Ing. Tech. 32 (1960), 413), should be at least 10 m²/g.

The final catalyst monolith preferably has a surface area in the range of from 10 to 1000 m²/g, more preferably 25 to 800 m²/g, most preferably 50 to 800 m²/g, e.g. 50 to 350 m²/g. The surface area is preferably determined by the single point BET method.

The pore volume is a further important requirement, whereby it is important that the total pore volume, as determined by mercury intrusion or nitrogen physisorption, is sufficiently high. In ab-solute terms the total pore volume should be at least 0.05 ml/g.

In specific embodiments, it may be desirable that the pore volume in pores of over 50 nm, more preferably over 250 nm and most preferably over 500 nm forms a substantial portion of the total pore volume.

In specific embodiments the ratio of the pore volume in pores of over 50 nm to total pore volume should preferably be more than 3%. An Fe-doped beta zeolite having those characteristics has good reactant accessibility, which makes it very suitable for catalytic reactions requiring good diffusion of reactants and products through the Fe-doped beta zeolite catalyst, thereby eliminating diffusion limitation problems as much as possible.

The pore volume and pore size distribution are determined by mercury porosimetry measurements, as described by J. Rouquerol et al. in Pure & Applied Chem., 66(8), 1994, pages 1752 to 1753, using the Washburn equation. Nitrogen physisorption is described by F. Schuth et al. in Handbook of Porous Solids, Wiley, 2002.

The pore volume of the final catalyst monolith is preferably in the range of from 0.05 to 2.0, more preferably 0.1 to 1.5, most preferably 0.2 to 1.2 ml/g.

The pore volume for pores over 50 nm is preferably in the range of 3 to 50%, more preferably 5 to 40% and most preferably 10 to 35%, based on the total pore volume.

The pore size distribution is a further important requirement. In specific embodiments, it can be preferable to obtain a transition alumina catalyst having a multi-modal pore size distribution, for example a bi-modal pore size distribution.

In accordance with this specification, a multimodal pore size distribution means a pore size distribution in which, when incremental pore volume is plotted as a function of pore size, the resulting function exhibits a maximum (or mode) within a first pore size range and a maximum (or mode) within a second pore size range. In general, a maximum (or mode) is the most frequently occurring number within a specific range of numbers. In relation to pore size distribution, the pore size maximum (or mode) is the pore size which, within a specific pore size range or within a subrange falling within such range, corresponds to the highest peak in a graph showing the pore size distribution. Therefore, in accordance with this specification, a multimodal pore size distribution means that within said first pore size range there should be at least one peak in a graph showing the pore size distribution, and within said second pore size range there should also be at least one peak in a graph showing the pore size distribution. Examples are multi-modal pore size distributions having two peaks as shown in FIGS. 2 and 3 of EP 2 231 559. The pore size may be the pore diameter or the pore radius.

Preferably, in the multimodal pore size distribution, the pore size range comprises a first pore size range and a second pore size range and the pore sizes in the first pore size range are smaller than the pore sizes in the second pore size range.

Preferably a first pore size range is a pore diameter range of from 0.1 to 50 nm (micropores and mesopores) and a second pore size range is a pore diameter range of greater than 50 nm, for example greater than 50 nm to smaller than 1500 nm (macropores). Preferably the maximum (or mode) in the first pore size range is at a pore diameter of from 5 to 50 nm, more preferably 10 to 30 nm. Further, preferably the maximum (or mode) in the second pore size range is at a pore diameter of from 50 to 1500 nm, more preferably 100 to 1250 nm.

Preferably the pore diameters corresponding to the maximums (or modes) in first and second pore size ranges are separated by at least 200 nm, more preferably at least 300 nm, and by at most 1,500 nm, more preferably at most 1000 nm.

The pore size distribution is determined according to the well-known mercury porosimetry method as described by J. Rouquerol et al. in Pure & Applied Chem., 66(8), 1994, pages 1752 to 1753, using the Washburn equation.

Preferably the catalyst to be used in the present invention has from 3 to 50%, more preferably 5 to 40%, and most preferably 10 to 30%, of the total pore volume in pores having a diameter greater than 50 nm (macropores). Further, preferably the catalyst has from 50 to 97%, more preferably 60 to 95%, and most preferably 70 to 90%, of the total pore volume in pores having a diameter from 0.1 to 50 nm (micropores and mesopores). Still further, preferably the catalyst has less than 3%, more preferably less than 2% and even more preferably less than 1%, of the total pore volume in pores having a diameter greater than 1500 nm. Most preferably, the catalyst has essentially no pore volume in pores having a diameter greater than 1500 nm.

As indicated above, the use of monolith shaped extrudates is important in terms of pressure drop in relation to accessibility of the internal surface of the transition alumina. This also plays a role in eliminating diffusion problems. Another advantageous property of the monolith shaped extrudates is the fact that the ratio of external surface area to volume is more advantageous than in the case of conventional shaped bodies used in catalysis.

Important aspects of the material of the invention are also the strength characteristics. As indicated above a side crushing strength of at least 10 N, preferably at least 20 N, and more preferably at least 30 N, most preferably at least 50 N, specifically at least 100 N and a bulk crushing strength of at least 0.1 MPa are preferred herein. These parameters form the basis for the suitability of the monolith extrudates for use in large scale reactors, like in the chemical and petroleum industry. When the monolith extrudates meet these requirements, they can be used in large fixed bed reactors that require very strong catalysts. The side crushing strength and the bulk crushing strength are defined as follows:

The side crushing strength (SCS) of the catalyst monolith, preferably with dimensions 1.5 cm×1.5 cm×1.2 cm (x,y,z axis, z being the stacking direction), according to the present invention is preferably at least 50 N, more preferably at least 60 N, more preferably at least 100 N, most preferably at least 300 N, when yz or xy opposite planar sides are pressed.

The SCS of shaped bodies is defined as the pressure (in Newtons) at which these are crushed, when treated under pressure.

The determination of the SCS is for examples disclosed in Oil & Gas Science and Technology—Rev. IFP, Vol. 55 (2000), No. 1, pp. 67 to 85, specifically section 3.1.1. An example for the determination of the SCS covering the resistance of a shaped catalyst body to a compressive force is as follows: The shaped body is subjected to a compressive load between jaws. The force required to crush the shaped body is measured and recorded in Newton force. The operation is executed using the semi-automatic Schleuniger Model 6D hardness tester. The shaped body is tested with the YZ or XZ plane facing upright between the measure jaws. Press the “START”-button on the Schleuniger 6D. The jaws will slowly approach each other to execute the crushing test. The crushing strength is displayed on the Schleuniger and the computer monitor.

The maximum SCS depends on the materials used for preparing the catalyst monolith and also on the three-dimensional structure of the catalyst monolith as well as the fiber diameter. The more contact points between the individual fiber layers are present, the higher the side crushing strength will be. Preferably, adjacent layers have at least 10 contact points, more preferably at least 20 contact points, most preferably at least 30 contact points to one neighboring layer. Thus, for a fiber layer, which has two neighboring layers, the number of contact points is twice the number stated above. Due to the contact points, the stack of fiber layers is self-supporting.

There is no upper limit for the SCS of the catalyst monolith. Typically, the maximum SCS is 100,000 N and often it is 10,000 N. Thus, the SCS of the catalyst monolith according to the present invention is preferably in the range of from 60 to 100,000 N, more preferably 100 to 100,000 N and most preferably 300 to 100,000 N.

The maximum can also be the maximum that a machine for measuring SCS is able to measure. The maximum can depend on the size of the monolith. If the monolith is larger than the machine for measuring it allows, the monolith is cut to a suitable size, preferably 1.5 cm×1.5 cm×1.2 cm (xyz axis).

The bulk crushing strength (BCS) of a catalyst is defined as the pressure (in Megapascals) at which 0.5% fines (i.e. particles less than 0.425 mm) are formed when treated under a piston in a tube. For that purpose, 17 ml of shaped catalyst bodies, pre-screened on a 0.425 mm sieve, are loaded in a cylindrical sample tube (diameter 27.3 mm), and 8 ml steel beads are loaded on top. The shaped bodies are subsequently treated at different (increasing) pressures for three minutes, after which the fines are recovered and their percentages are determined. This procedure is repeated until a level of 0.5 wt % fines is reached.

Another aspect of the strength of the material is the attrition, i.e. the amount of material that may break off of the extrudates upon use. This attrition, determined in accordance with ASTM D4058-87, should preferably be less than 10 wt %, more preferably less than 7.5 wt %, in particular less than 5 wt %.

The Fe-doped beta zeolite extrudates having the above properties can be prepared by mixing, Fe-doped beta zeolite particles adding a binder and/or a suitable plasticizer pore-forming material in the presence of a liquid, usually water or an aqueous solution of a mineral acid peptization agent such as hydrochloric, sulfuric, nitric, acetic or formic acid, to form a paste, followed by extruding of the paste in the required form, using a suitable die.

It is possible to use various types of binder materials, such as those based on silica or clays or mixtures thereof. The binder may also be selected from organic materials. Although upon calcination mixed oxides may form, due to the low amount of binder this does not affect the principal character or composition of the monolith.

Hydroxide precursors suitable as binders comprise gibbsite, bayerite, nordstrandite and doyleite.

Oxyhydroxide precursors suitable as binders comprise diaspore, boehmite, pseudoboehmite and akdalaite or tohdite.

Although the common transition aluminas are often derived from hydroxide or oxyhydroxide precursors obtained from the Bayer process and find many catalytic applications, high-purity precursor materials (e. g. pseudoboehmite from the Ziegler process, for linear alcohol production) are sometimes preferred.

For the synthesis of Fe-doped beta zeolite catalysts also mixtures of different hydroxide precursors, mixtures of different oxyhydroxide precursors or mixtures of hydroxide and oxyhydroxide precursors of the binders may be applied.

To modify the surface properties, acidity and alkalinity of Fe-doped beta zeolite catalysts (“doping”) other element precursors may be included on purpose in a range of 0.1 wt % to 10.0 wt %, based on their content in the final Fe-doped beta zeolite.

Suitable binders are alumina hydrates like boehmite (AlOOH) or bayerite (Al(OH)₃) which can be obtained as Pural® SB from Sasol.

The amount of binder material in the suspension paste is not more than 50 wt %, preferably 0.1 to 50 wt %, more preferably 30 wt %, even more preferably 0.1 to 20 wt %, e.g. preferably in the range of from 0.1 to 15 wt %, more preferably 1 to 10 wt %, and most preferably 2.5 to 5%, based on the amount of Fe-doped beta zeolite particles in the suspension paste.

It may furthermore be required to use an organic plasticizer to obtain a uniform mixture and to transform the mixture into a compound with rheological behavior. The plasticizer may be chosen from organic materials such as for example waxes. It is preferred to use a plasticizer that is re-moved during calcination, while providing and maintaining the required strength. The amount of plasticizer used in the preparation of the paste that is to be extruded will vary depending on the type of material and the required properties. Generally, it will not be in excess of 10 wt %, preferably not in excess of 1.5 wt %, more preferably not in excess of 2.5 wt % based on the amount of Fe-doped beta zeolite particles thereof. A preferred plasticizer is a polyalkylene oxide, more preferably a polyethylene oxide which can be obtained as Alkox E-160 from Meisei Chemical works, Ltd.

Preferably, the amount of plasticizer, if applied to the mixture, will not be in excess of 10 wt % based on the total weight of the suspension paste.

The pore-forming material is preferably a cellulose material, more preferably a cellulose ether, most preferably selected from hydroxyethyl methylcellulose (HEMC), methylcellulose (MC), hydroxypropyl methylcellulose (HPMC) or mixtures thereof. The amount of the pore-forming material is not more than 30 wt %, preferably in the range of from 0.1 to 20 wt %, more preferably 0.5 to 10 wt %, and most preferably 1 to 6 wt %, based on the amount of Fe-doped beta zeolite particles in the suspension paste.

The peptization agent is preferably an inorganic acid, more preferably nitric acid. The amount of peptization agent in the suspension paste is not more than 7 wt %, preferably in the range of from 0.05 to 5 wt %, more preferably 0.1 to 3 wt %, and most preferably 0.2 to 1 wt %, based on the amount of Fe-doped beta zeolite particles in the suspension paste.

In the method according to the present invention the suspension paste in step a) contains no fibers or only very low amounts of fibers. The fibers are selected from organic fibers and inorganic fibers, and can be present in a total amount of 0 to 3 wt %, preferably 0 to 0.9 wt %, more preferably 0 to 0.45 wt %, most preferably 0%, based on the suspension paste. Fibers are elongated solid bodies having a length that is at least 4 times, more preferably at least 8 times, most preferably at least 15 times the (largest) diameter length. For fibers having a noncircular cross-section, the largest crosssection-diameter is considered here. Thereby, the paste is different from the pastes described in US 2007/0259770 and US 2009/0291824.

The final suspension paste preferably has a suitable viscosity for an extrusion through a nozzle as described below

For the Fe-doped beta zeolite catalyst, a preferred number average particle size in step a) is in the range of from 0.05 to 700 μm, preferably 0.5 to 500 μm, more preferably 1 to 250 μm.

In this respect, average particle sizes can be measured by sieving the particles or by laser diffraction techniques or by photographic techniques like camsizer techniques. The average particle size refers to the number average particle size or arithmetical average particle size. For irregular particle shapes, the number average maximum particle diameter is measured.

The suspension paste prepared in step a) of the process according to the present invention preferably has a solids content of 1 to 95 wt %, more preferably 10 to 65 wt %.

The 3D robocasting technique employed according to the present invention is well established and can be performed as described in U.S. Pat. Nos. 7,527,671, 6,027,326, 6,401,795, WO 2019/229040, Catalysis Today 273 (2016), pages 234 to 243, or Journal of Catalysis 334 (2016), pages 110 to 115, or U.S. Pat. No. 6,993,406.

The 3D robocasting technique can be used with catalyst formulations which can be based on pastes that are currently used in standard extrusion techniques provided the particle size is small enough to pass the extrusion nozzle. The extrusion formulation or paste contains transition alumina particles, hydroxide precursor particles or oxyhydroxide precursor particles thereof or mixtures thereof. If necessary, a binder and/or a plasticizer can be added to the extrusion mixture.

The robocasting technique implies the extruding through one or more nozzles preferably having a maximum diameter of less than 5 mm, more preferably of less than 1 mm, most preferably less than 0.8 mm. Specifically, the diameter of the nozzle should be in the range of from 0.05 mm to 0.4 mm, most preferably from 0.2 mm to 0.4 mm. The nozzle can have any desired cross-section, e. g. circular, elliptical, square, star-shaped, lobbed. The maximum diameter is the largest diameter of a non-circular cross-section.

One of the main criteria for robocasting is the use of an extrudable paste that has the correct rheological properties for the robocasting technique. The above-mentioned literature gives de-tailed advice as how to obtain the required rheological properties.

If necessary, in the process according to the present invention, a viscosity adjusting agent can be employed. Typical viscosity adjusting agents are celluloses like carboxymethyl cellulose. Preferably, no (additional) viscosity adjusting agent is employed.

The term “porous” employed here defines that the monolith is not a solid block of material but contains channels or pores. By stacking spatially separated catalyst fiber layers in an ABA or ABACA, also referred to as ABC, manner, through-channels or pores can be formed. Thereby, pathways with direct line-of-sight or pathways with no direct line-of-sight can be formed.

The porosity is preferably at least 20%, more preferably at least 30% and can preferably be in the range of from 20 to 90%, and can be determined by nitrogen physisorption, Hg-PV and He-density. It can be determined by the following formula. Porosity(%)=100−[(density of total microextruded structure/density of fiber material)×100]. The density of the total microextruded structure is determined by dividing its total weight by its total volume. The density of the fiber material can be determined by measuring Hg-PV and He-density.

Since the lattices or scaffolds formed from the fibers are self-supporting, open space remains between the fibers which leads to the porosity. Respective structures can be seen in the above-mentioned literature. They show a low pressure drop when employed in a reactor.

The robocasting process employed according to the present invention can also be described as 3D fiber deposition.

### General Description of 3DFD

3D Fiber Deposition (3DFD) is used to shape the powder. The 3DFD method is an adaptive manufacturing method whereby a highly loaded paste is extruded by a moving nozzle. By computer controlling the movement of the extrusion head in x, y and z-direction, a porous material can be produced from the extruded fibers or strands layer by layer. After drying, the porous material can be thermally treated.

The main benefit of this technology is the degree of freedom with regard to the porous parameters (fiber thickness, interfiber distance and stacking design).

The typical flow chart for the 3DFD technology consists of the following subsequent steps:
Prepare highly viscous paste
Extrude through thin nozzle
Computer controlled deposition of fibers to form a porous periodic structure
Drying and if necessary reducing

The first important step is to make sure that no large particles are present in the paste. Therefore, the particle size of the starting material is checked. If too large particles are present, the powder is sieved to obtain the desired particle size. As a rule of thumb, the largest particle (rep-resented by the D 99 value) should preferably be at least five times smaller than the nozzle size that will be used, more preferably at least ten times smaller.

In the following step the powder is mixed together with the solvent/diluent (e. g. water), if necessary binder and additives such as plasticizers, are added, thus obtaining a viscous paste. A good mixing to achieve a homogenous paste (minimizing agglomerates or the incorporation of air bubbles) is a prerequisite for a smooth and reproducible process. The powder loading of the functional material depends on the specific surface area, the particle size distribution and the powder morphology. Generally, as the particle size of the powder decreases, the viscosity of the paste will increase. Therefore, the solid loading needs to be lowered for these powders. Apart from organic or, preferably, inorganic binder(s), plasticizers can be added to control the rheological behavior of the paste. In some cases a defoamer is also added to avoid air bubbles in the paste.

After mixing and de-airing, the paste is transferred to the paste reservoir and mounted on the 3DFD set-up. The nozzle, preferably either plastic or metal (below 200 μm), is attached to the paste reservoir. Paste extrusion is achieved e. g. by a displacement pump or a screw pump. During deposition, it might be necessary to control the drying conditions.

After drying at room conditions (or under controlled atmosphere and temperature), the 3DFD structure is dried and thermally treated, if necessary. No heat treatment at temperatures above 1000° C. is necessary.

### Experimental Procedure of 3DFD Process

Obtaining a smooth process and a narrow control on the extrusion of thin filaments often re-quires adjustments of both the formulation of the paste and the experimental set-up. The main process parameters which have to be addressed are listed below.

### Parameters

Particle size distribution of starting material
Preparation and mixing procedure of the paste
Paste formulation
De-airing & paste reservoir filling
Design of deposition platform
Height control of nozzle
Programming of turns and transition between layers
Tuning extrusion speed versus movement speed
Drying conditions during deposition

For a further description of the process, reference can be made to the above-listed documents.

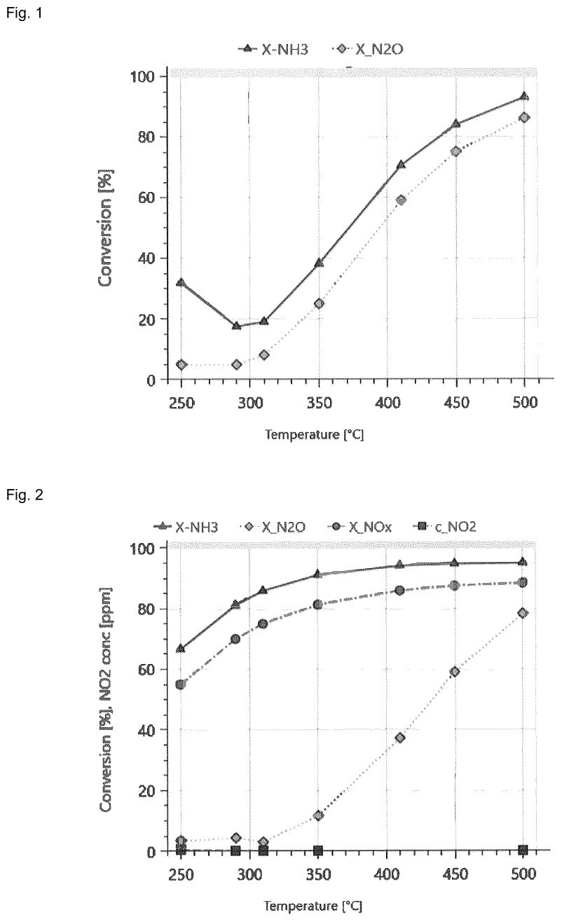

The stacking design is preferably as depicted in FIGS. 1 and 2 of U.S. Pat. No. 7,527,671. Most preferred is a 1-3-1 pattern or 3 DFD structure 1-3 or 1-1 as shown in FIG. 3 of Chemical Papers 68 (9), pages 1143-1153 (2014) or (1.1) stacking or (1.3.5) stacking as shown in FIG. 1 of Int. J. Appl. Ceram. Technol. 9 [5], pages 902-910 (2012).

The liquid diluent employed can be chosen from water and organic liquid diluents. Preferably, the liquid diluent contains mainly or is water.

The drying is preferably performed at a temperature in the range of from −100 to 500° C., more preferably 0 to 300° C., most preferably 20 to 150° C.

No treatment of the porous catalyst monolith precursor or porous catalyst monolith at temperatures above 600° C., preferably above 550° C., more preferably above 500° C., is performed.

The monolith of stacked catalyst fibers is preferably three-dimensionally structured by depositing the extruded fibers in regular, recurring stacking pattern (periodically structured catalyst), to form a three-dimensionally structured porous catalyst monolith precursor.

The monolith can be formed from one continuous extruded fiber or from multiple individual extruded fibers.

Preferably, the regular, recurring stacking pattern is composed of stacked layers of extruded fibers, wherein in each layer at least 50 wt %, more preferably at least 90 wt % of the extruded fibers or each of the fibers are deposited parallel to each other and spatially separated from each other. The parallel deposition can be in straight or curved lines. As an alternative, they can be deposited/stacked in a circular pattern with radial interlayers, like in a cobweb pattern.

More preferably, at least 50 wt %, most preferably at least 90 wt % of the extruded fibers or each of the fibers are deposited as linear strands parallel to each other and spatially separated from each other, wherein the direction of the strands in each layer is different from the direction in neighboring layers, so that a porous structure with contact points of strands of neighboring stacks result. As an alternative, multiple cobweb patterns can be stacked, each pattern layer preferably rotated relative to its neighboring pattern layers.

One example of stacks of layers alternating by 90° in the direction is depicted in FIGS. 1 and 2 of U.S. Pat. No. 7,527,671.

The fibers or strands preferably have a thickness of 10 to 5000 μm, more preferably 10 to 1000 μm, most preferably 150 to 500 μm.

They are preferably spatially separated from each other by 10 to 5000 μm, more preferably 100 to 1000 μm, most preferably 200 to 800 μm.

One example is a stacking of 360 μm strands being spaced by 650 μm.

Typical monolith sizes are 1 mm³ and above, preferably 1 mm³ to 100 m³, more preferably 3 mm³ to 300 m³.

The monolith can have any desired shape. Preferably, it is in the form of a cylinder with circular or ellipsoidal cross section, a cuboid, a sphere, an ellipsoid, a tablet or a polygon.

In comparison to this, typical extrusion processes for transition alumina catalyst extrudates yield extrudates with a minimum diameter of 1.2 mm. Depending on the formulation, these extrudates have a strength of lower than 10 N or lower than 100 N as measured by the SCS method (side crush strength).

Structures made from 360 μm fibers and 650 μm interfiber distance and ABAB or ABC stacking show a side crushing strength of a 1.5 cm-1.5 cm-1.5 cm structure of more than 100 N.

Thus, the process according to the present invention leads to catalyst structures having a high strength combined with high porosity and high geometric surface area and high packing density.

The invention also relates to a three-dimensional porous catalyst monolith of stacked catalyst fibers, obtainable by the above process.

The invention furthermore relates to the use of these monoliths as catalysts in selective catalytic reduction reactions. Preferably, the reactions involve a gas phase, a liquid phase or mixed liquid/gas phase. Reference can be made to the patent and non-patent documents discussed above.

The invention furthermore relates to a control system data set containing a plurality of control instructions which when implemented on an additive production facility prompt the additive production facility to produce a three-dimensional porous catalyst monolith or three-dimensional porous catalyst monolith precursor as described above.

Additive production facilities are for example 3D fiber deposition (3DFD), 3D printing, stereolitography, fused filament fabrication (FFF) or laser sintering. These facilities or equipments are used to shape the powder or paste in order to form the three-dimensional catalyst monolith or its precursor. Thus, the additive production facility can be a 3D fiber deposition printer, 3D printer, stereolitography device or laser sintering device. These production facilities or production equipments are typically computer-controlled using a CAD file (computer aided design file). The CAD file contains the information on the three-dimensional structure of the porous catalyst monolith or its precursor and is needed to operate the additive production facility.

This CAD file which can also be described as a control system data set contains a plurality of control instructions which drive the additive production facility, for example the moving nozzle in a 3D fiber deposition apparatus. The control system data set can also be described as control system data record or data drive set. The control system data set or CAD file contains all information necessary to drive the additive production facility in order to produce the monolith or monolith precursor. This meaning is encompassed by the term “prompt” as used above. The control system data set and control instructions are typically electronic data stored on appropriate data storing device which can be a CD, DVD, USB stick, hard drive or SSD drive of a computer or attached to a computer.

The control system data set is typically loaded to the computer controlling the additive production facility prior to printing or extruding the 3D structure. Thus, the term “implementing” typically means loading the control system data or control instructions in a computer system which operates the additive production facility. Thus, the additive production facility then has the control instructions implemented thereon.

The Fe-doped beta zeolite catalyst monoliths of the present invention show a lower pressure drop, a higher activity and a higher selectivity when compared to normal extrudates. Since more external surface of the catalyst is facing reactants, more of the catalyst is immediately available. Thus, the residence time of the reactant in the catalyst can be shortened due to the faster transport. Consequently, less side products are formed.

The robocasting process allows for the manufacture of three-dimensional porous catalyst monolith structures of stacked catalyst fibers, which have an increased external surface area and/or increased side crushing strength of preferably at least 50 N, more preferably at least 60 N in comparison to normal extrudates.

Furthermore, higher catalyst densities in the reactor can be achieved due to well-ordered stackings of fibers. A packing density of up to 70% is possible by employing regularly stacked catalyst fibers prepared according to the present invention.

The low pressure drop allows to work with smaller fiber diameters compared to single extrudates.

The invention will be further illustrated by the following examples.

### Example of 3D Microextruded Catalyst:

Fe-doped (template-free) beta zeolite (Fe-TF-beta):
nitric acid to peptize; Pural SB (Al2O3 binder)
avoid low pH<2.9 to avoid dealumination and damage to zeolite framework
final calcination T<500° C.

### CoA

$$BET \geq 480 m 2 / g$$

2.8-3.5 wt. % Fe; 34-36 wt. % Si and 6.8-7.2 wt. % Al→SAR 9-11; low Na (≤0.05 wt. % Na as Na2O)
XRD: relative crystallinity≥95% or 71-73%
LOI: ≤10 wt. %
aim particle size: d10 1-2 μm, d50 1-6 μm, d90 2-25 μm
Walocel® MW 15000 GB Dow/Dupont
NaCl (0.5-3%)
hydroxyethyl methylcellulose (CAS: 9032-42-2) HEMC
Alkox E-160 Kowa Europe GmbH or Meisei Chemical Works
EO homopolymer
high viscosity, MW~4,000,000; at 0.5 wt. %→100-200 mPa·s (aqueous solution)
first extrudates:
piston press; Pural® SB from Sasol as binder, HNO₃ for peptization; zeolite content: 70, 75 and 80 wt. %
extrusion trials
3 mm extrudates
Walocel®, PEO, nitric acid, zeolite binder, water
important parameter: HNO₃ concentration→below 1 wt. % for stable extrusion with 3.0 mm die BUT compromise of mechanical properties and pore volume (Hg-PV<0.4 ml/g)
recipe (sum is >100 wt. % and doesn't include acid or water)
Fe-TF-beta 200 kg (70 wt. %)
Pural SB® 109 kg (30 wt. %)
Nitric acid 58% 1.6 kg (no HNO₃)
Alkox E-160 3.1 kg 4 PEO (1 wt. %)
Walocel MW15000 GB 9.3 kg (3 wt. %)
Water 206 kg

### Addition Order

MC+Fe-TF-beta+Pural® SB (dry blending)
H₂O (activation, mixing DAC)
HNO₃ solution (peptization)
Fe-TF-beta (solid content adjustment)
“aging”=overnight

### 3D Microextruded Porous Fe-Doped Beta Zeolite Catalyst Monolith

Suspensions were made from the above ingredients including Fe-doped beta zeolite particles, water and acid (HNO₃). The ingredients were manually added and mixed to obtain the right rheological properties for extruding through a 400 μm sized nozzle. The particle size of the powder was selected to allow for this extrusion. The suspension is brought in a dispensing unit consisting of a syringe vessel and a nozzle. The unit is mounted on a micro-extruder machine. The micro-extruder is a computer numerical control (CNC) machine that is programmed to move according to a well-defined pattern and within a well-defined form. The CNC machine is programmed to continuously deposit filaments layer by layer in a predefined pattern. The deposition parameters, e. g. the distance between the nozzle and the surface of the structure, the speed of the nozzle movement, the air pressure and the temperature and airflow of the environment, etc. are regulated. A 3D-structure is built in a box by depositing the filaments layer by layer according to the programmed pattern and according to the required dimensions. All 3D structures were afterwards dried at 80° C.
A) A temperature treatment at 450° C. was applied to form a porous Fe-doped beta zeolite catalyst monolith. The dimensions of the monolithic structure after temperature treatment were 1.91 cm×1.90 cm×0.74 cm (length, width, height). The porous properties of the monolith were found to be: BET surface area 184 m2/g, total pore volume 0.73 mL/g and SCS>720 N.

### De-NOₓ Experiments

For De-NOₓ testing of 3D-microextruded Fe-doped beta zeolite catalysts, 25 cc of catalyst was loaded into a 1″ OD (0.834″ ID)×4 ft stainless steel fixed-bed downflow reactor.

The reactor was equipped with a thermowell that housed five thermocouples.

The reactor was heated by a furnace, with the catalyst loaded such that its location was in the middle furnace section.

Catalyst mass loading was determined by multiplying catalyst bulk density by 25 cc.

In the case of the cylinders [Example 1B], a monolith structure was prepared as shown in Catalysis Today 216 (2013), page 21, FIG. 4 with the 1-3 stacking pattern of the 3DFD structure. In each layer, 5 strands were deposited having a diameter each of 1.5 mm. The spacing between 2 strands was also 1.5 mm. In contrast to the picture shown in Catalysis Today 216 (2013), page 21, FIG. 4 (a), in each layer one continuous strand was deposited in a zick-zack manner providing linear parallel strands connected by U-shaped connecting portions thereof thereby giving one continuous strand per layer. The resulting cylindrical monoliths had the following nominal dimensions: OD=20.8 mm, height=17.0 mm with a nominal particle mass of approximately 3 g. The cylindrical monoliths were formed such that they could be stacked single file in the reactor.

For preparing these cylindrical monoliths, the nozzle size was adjusted accordingly.

In the case of the cylinders [Example 1C], bulk density was determined based on normal packing density of cylinder elements with the following nominal dimensions: OD=20.8 mm, ID=5.56 mm, h=16.74 mm with a nominal particle mass of 2.814 g. The cylinders were formed such that they could be stacked single file in the reactor with the thermowell protruding through a center hole which was cut out.

In all cases, ⅛″ Denstone spheres were used as bed support and in the pre-heat zone above the catalyst bed to provide surface area for the feedstock to vaporize.

Once loaded, the reactor was purged with 300 sccm N₂ for approximately 30 minutes to remove air and subsequently heated to 400° C. under flowing N₂ and held for at least 4 hours.

Once pretreatment of the catalyst was completed, the reactor was cooled to 200° C. and pressurized to 14.5 psig. Once pressure and temperature were stable, N2 flow was stopped and feed consisting of 100 ppm N₂O, 1000 ppm ammonia, 8 wt.-% water, in argon carrier gas was introduced to the reactor at a rate of GHSV=50.000 hr⁻¹, where GHSV is defined as volumetric flow rate of gas per catalyst volume. The reactor was held at these conditions for approximately 24 hours at up to 500° C.

Product analysis was performed with an online gas chromatograph equipped with a flame ionization detector (FID), a heated sample injection valve, and an HP-PLOT Q capillary column (30 m×0.320 mm×20 μm). The reaction effluent was delivered to the GC through heated sample lines at ~180-200° C. and injected approximately every 15 min.

The following quantities were calculated and used to assess and compare catalyst performance: percent N₂₀ and NOₓ conversion.

### Test

### Test Conditions:

Catalyst B

$$M\_Kat = 14.5 g$$

$$GHSV = 50. {hr}^{- 1}$$

Total flow 1816 l/h
Temperatures: 250, 290, 310, 350, 410, 450, 500° C.
Run 1: 100 ppm N₂0, 200 ppm NH₃, 10% O₂ in argon carrier gas
Run 2: 100 ppm N₂0, 1000 ppm NH₃, 1000 ppm No, 10% O₂, 8% H₂O in argon carrier gas

FIG. 1 shows Run 1—N₂O abatement in the presence of NH₃100 ppm N₂O+200 ppm NH₃

In the presence of 200 ppm NH₃ the N₂O conversion curve is shifted to slightly lower temperatures, but still 350° C. are required to achieve substantial N₂0 conversions.

FIG. 2 shows Run 2—SCR+N₂O abatement 100 ppm N₂0+1000 ppm NH₃+1000 ppm NO+8 vol. % H₂O.

In the presence of 100 ppm NO and NH₃ up to 80% N₂0 conversion are obtained at 500° C. for fresh and HT aged Fe BEA catalysts. With stoichiometric feed (NH₃/NO ratio=1) no NO₂ formation is observed up to 500° C.

1.-14. (canceled)

15. A method for producing a three-dimensional porous Fe-doped beta zeolite catalyst monolith of stacked catalyst fibers, comprising the following steps:
a) preparing a suspension paste in a liquid aqueous diluent of Fe-doped beta zeolite particles and which suspension furthermore comprises a binder material in a maximum amount of 50 wt %, based on the amount of Fe-doped beta zeolite particles and a plasticizer and a pore-forming material, each in a maximum amount of 10 wt %, based on the amount of Fe-doped beta zeolite particles, and a peptization agent in a maximum amount of 5 wt %, based on the amount of Fe-doped beta zeolite particles, all particles in the suspension having a number average particle size in the range of from 0.05 to 700 μm,
b) extruding the paste of step a) through one or more nozzles to form fibers, and depositing the extruded fibers to form a three-dimensional porous catalyst monolith precursor,
c) drying the porous catalyst monolith precursor to remove the liquid diluent, and
d) performing a temperature treatment of the dried porous catalyst monolith precursor of step c) at a temperature in the range of from 300 to 600° C., to form the Fe-doped beta zeolite catalyst monolith,
wherein no temperature treatment of the porous catalyst monolith precursor or porous catalyst monolith at temperatures above 600° C. is performed and wherein no further catalytically active metals, catalytically active metal oxides or catalytically active metal compounds are applied to the surface of the Fe-doped beta zeolite particles, the catalyst monolith precursor or Fe-doped beta zeolite catalyst monolith, and are not present in the suspension paste, with the exception of copper, wherein in step b) the nozzles have a maximum diameter of less than 5 mm, and wherein the suspension paste in step a) contains 0 to 0.9 wt % fibers, selected from organic fibers and inorganic fibers, based on the suspension paste.

16. The method of claim 15, wherein the pore-forming material comprises a cellulose material.

17. The method of claim 16, wherein the cellulose material comprises a cellulose ether.

18. The method of claim 16, wherein the cellulose material comprises hydroxyethyl methylcellulose, methylcellulose, hydroxypropyl methylcellulose or mixtures thereof.

19. The method of claim 15, wherein the Fe-doped beta zeolite is obtained from an organotemplate-free synthetic process.

20. The method of claim 15, wherein in step b) the nozzles have a maximum diameter of less than 1 mm.

21. The method of claim 15, wherein the monolith of stacked catalyst fibers is three-dimensionally structured by depositing the extruded fibers in a regular, recurring stacking pattern to form a three-dimensionally structured porous catalyst monolith precursor, wherein in each layer at least 50 wt % of the extruded fibers are deposited parallel to each other and spatially separated from each other, or in a cobweb pattern.

22. The method according to claim 21, wherein at least 50 wt % of the extruded fibers are deposited as linear strands parallel to each other and spatially separated from each other, or wherein multiple cobweb patterns are stacked, wherein the direction of the strands in each layer is different from the direction in neighboring layers, so that a porous structure with contact points of strands of neighboring layers results.

23. The method according to claim 15, wherein the plasticizer comprises an organic plasticizer, or wherein the peptization agent comprises an inorganic acid.

24. The method according to claim 23, wherein the organic plasticizer comprises a polyalkylene oxide, or wherein the peptization agent comprises nitric acid.

25. The method according to claim 15, wherein a binder material is employed, and wherein the binder material comprises one or more inorganic binders.

26. The method of claim 15, wherein the Fe-doped beta zeolite catalyst monolith has a BET surface area above 50 m²/g or wherein the Fe-doped beta zeolite catalyst monolith has a pore volume above 0.25 ml/g or wherein the Fe-doped beta zeolite catalyst monolith has a monomodal or polymodal pore size distribution.

27. The method according to claim 15, wherein the suspension paste in step a) contains fibers, selected from organic fibers and inorganic fibers, in an amount of 0 to 0.45 wt %, based on the suspension paste, or wherein the suspension paste in step a) contains Fe-doped beta zeolite particles in an amount of 60 to 90 wt %, based on the suspension paste.

28. A three-dimensional porous catalyst monolith of stacked catalyst fibers, obtained by the method according to claim 15.

29. A method for selective catalytic reduction reactions of NOₓ, the method comprising using the three-dimensional porous Fe-doped beta zeolite catalyst monolith of stacked catalyst fibers according to claim 28.

30. The method according to claim 29, wherein the reaction is the N₂O abatement.

31. The method according to claim 29, wherein reduction is performed in the presence of ammonia.
